(19) United States
(12) Patent Application Publication
(10) Pub. No.: US 2017/0028328 A1
(43) Pub. Date: Feb. 2, 2017

(54) WATER FILTER AND MANIFOLD

(71) Applicant: FILBUR MANUFACTURING LLC, La Palma, CA (US)

(72) Inventors: Victor Parra, Fontana, CA (US); Bruce Stump, La Palma, CA (US); Joseph Marcotte, Lakeway, TX (US)

(21) Appl. No.: 15/219,566

(22) Filed: Jul. 26, 2016

Related U.S. Application Data
(60) Provisional application No. 62/198,987, filed on Jul. 30, 2015.

(51) Int. Cl. B01D 35/30; B01D 29/21; F16L 41/02; B01D 29/58

(52) U.S. Cl. CPC B01D 35/306; B01D 29/58; B01D 29/21; F16L 41/02; B01D 2201/307; B01D 2201/12; B01D 2201/295

(57) ABSTRACT

According to various aspects and embodiments, a modular water filtration system is provided. The water filtration system comprises a housing having an inlet port and an outlet port, at least one filter cartridge disposed within the housing and in fluid communication with unfiltered water introduced through the inlet port of the housing, and a manifold disposed within the housing and having at least one discharge port in fluid communication with the outlet port and at least one conduit in fluid communication with filtered water that has passed through the at least one filter cartridge, the manifold configured to mechanically couple to the filter cartridge.

### CROSS REFERENCE TO RELATED APPLICATIONS

This application claims priority under 35 U.S.C. §119(e) to U.S. Provisional Application Ser. No. 62/198,987, titled “WATER FILTER AND MANIFOLD,” filed Jul. 30, 2015, which is incorporated herein by reference in its entirety.

### TECHNICAL FIELD

The technical field relates generally to water filtration systems and, more particularly, to a modular water filtration system that includes at least one filter and a manifold.

### BACKGROUND DISCUSSION

Many water filtration systems recycle water through one or more filter cartridges to prevent the accumulation of foreign matter that could otherwise damage or impair the system. One or more filter cartridges may be placed within a housing into which the fluid is introduced for filtering and then later removed as filtered effluent. Examples of such filter systems are disclosed in U.S. Pat. Nos. 3,988,244, 4,537,681, and 5,190,651. The filter cartridges of these systems use dual flow paths, where fluid that is to be filtered is introduced through a central inlet. A portion of this fluid then flows from the central area radially outward through an inner filter element. The remainder of the fluid flows to the outer perimeter of the cartridge and from there, flows radially inward through an outer filter element. Both flows join at an annular passage (a space between the filter elements) and pass downward to a discharge port.

### SUMMARY

Aspects and embodiments are directed to a water filtration system that includes a housing, at least one filter cartridge, and a manifold. According to various aspects, the at least one filter cartridge may be disposed within the housing so as to be in fluid communication with unfiltered water introduced through an inlet port of the housing. The manifold may also be disposed within the housing and may include at least one discharge port that is in fluid communication with an outlet port of the housing. The manifold may also be configured to mechanically couple to the at least one filter cartridge and may include at least one conduit that is in fluid communication with filtered water that has passed through the at least one filter cartridge.

According to one aspect of the invention, a water filtration system is provided comprising a housing having an inlet port and an outlet port, at least one filter cartridge disposed within the housing and in fluid communication with unfiltered water introduced through the inlet port of the housing, and a manifold disposed within the housing and having at least one discharge port in fluid communication with the outlet port and at least one conduit in fluid communication with filtered water that has passed through the at least one filter cartridge, the manifold configured to mechanically couple to the at least one filter cartridge and the housing.

According to one embodiment, the manifold includes at least one alignment feature configured to mate with a recess disposed on a lower end cap of the at least one filter cartridge. According to one embodiment, the recess is a continuous groove. According to another embodiment, the recess is a series of openings.

According to one embodiment, the at least one filter cartridge includes at least one outlet port configured to be in fluid communication with the at least one conduit of the manifold.

According to another embodiment, the at least one filter cartridge includes an outer filter cartridge having a central annular region and an inner filter cartridge disposed within the central annular region of the outer filter cartridge, each of the outer filter cartridge and the inner filter cartridge in fluid communication with the manifold. According to another embodiment, the at least one conduit of the manifold includes an outer conduit and an inner conduit, and the outer filter cartridge is in fluid communication with an outer conduit and the inner filter cartridge is in fluid communication with the inner conduit.

According to another aspect of the invention, a kit for retrofitting an existing water filtration system is provided comprising, at least one filter cartridge configured to be disposed within the existing water filtration system, and a manifold configured to be disposed within the existing water filtration system, to mechanically couple to the at least one filter cartridge, and having at least one discharge port configured to couple to an outlet of the existing water filtration system.

According to one embodiment, the at least one filter cartridge is configured to be in fluid communication with unfiltered water introduced through an inlet of the existing water filtration system, and the manifold further includes at least one conduit in fluid communication with filtered water that has passed through the at least one filter cartridge and in fluid communication with the at least one discharge port. According to another embodiment, the at least one filter cartridge includes at least one outlet port configured to be in fluid communication with the at least one conduit of the manifold. According to another embodiment, the at least one filter cartridge includes an outer filter cartridge and an inner filter cartridge. According to anther embodiment, the at least one conduit includes an outer conduit configured to be in fluid communication with the outer filter cartridge, and an inner conduit configured to be in fluid communication with the inner filter cartridge.

According to another aspect of the invention, a manifold is provided comprising a first conduit configured to be in fluid communication with a first filter cartridge, a second conduit configured to be in fluid communication with a second filter cartridge, and at least one discharge port in fluid communication with the first conduit, the second conduit, and an outlet of a water filtration system.

According to one embodiment, the manifold further includes at least one alignment feature configured to mate with the first and second filter cartridges. According to another embodiment, the at least one alignment feature is at least one of a continuous groove and a series of openings.

According to another embodiment, the first conduit is an outer conduit and the second conduit is an inner conduit such that the inner conduit is nested within the outer conduit. According to one embodiment, the outer conduit and the inner conduit are in fluid communication with an outlet fitting coupled to the outlet of the water filtration system. According to another embodiment, the at least one discharge port includes an outer discharge port in fluid communication with the outer conduit and the outlet fitting, and an inner discharge port in fluid communication with the inner conduit and the outlet fitting. According to another embodiment, the manifold further comprises a center port configured to couple to the outlet fitting. According to another embodiment, the first conduit is in fluid communication with filtered water that has passed through the first filter cartridge and the second conduit is in fluid communication with filtered water that has passed through the second filter cartridge.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a perspective partial cut-away view of one example of a water filtration system in accordance with one or more aspects of the disclosure;

FIG. 2 is a combination schematic and partial cut-away perspective view of the water filtration system of FIG. 1 that includes fluid flow paths in accordance with one or more aspects of the disclosure;

FIG. 3 is a perspective view of one example of a housing for a water filtration system in accordance with one or more aspects of the disclosure;

FIG. 4 includes several views of different components of a water filtration system in accordance with one or more aspects of the disclosure;

FIG. 5 is a perspective view of an inner filter cartridge, an outer filter cartridge, and a manifold in accordance with one or more aspects of the disclosure;

FIG. 6 is an elevational side view of a manifold and an outlet fitting in accordance with one or more aspects of the disclosure;

FIG. 7 is a top view of the manifold and outlet fitting of FIG. 6;

FIG. 8 is a partial top view of an installed inner filter cartridge in accordance with one or more aspects of the disclosure;

FIG. 9 is a top view of an installed manifold in accordance with one or more aspects of the disclosure;

FIG. 10 includes several views of different components of a water filtration system in accordance with one or more aspects of the disclosure;

FIG. 11 is a top view of an outer filter cartridge in accordance with one or more aspects of the disclosure;

FIG. 12 is a bottom view of the filter cartridge of FIG. 11;

FIG. 13 is a bottom view of an inner filter cartridge in accordance with one or more aspects of the disclosure;

FIG. 14 includes several views of a manifold in accordance with one or more aspects of the disclosure;

FIG. 15 is a side elevational view of the manifold of FIG. 14;

FIG. 16 is a bottom view of the manifold of FIG. 14;

FIG. 17 is another bottom view of the manifold of FIG. 14;

FIG. 18 is a bottom plan view of the manifold of FIG. 14;

FIG. 19 is another bottom view of the manifold of FIG. 14;

FIG. 20 is a top plan view of the manifold of FIG. 14;

FIG. 21 is a top view of the manifold of FIG. 14;

FIG. 22 is a partial cross-sectional view of the manifold of FIG. 14;

FIG. 23 is perspective partial cut-away view of an inner support structure in accordance with one or more aspects of the disclosure;

FIG. 24 is a perspective partial cut-away view of another example of a water filtration system in accordance with one or more aspects of the disclosure;

FIG. 25 is a perspective partial cut-away view of yet another example of a water filtration system in accordance with one or more aspects of the disclosure; and

FIG. 26 is another example of a housing for a water filtration system in accordance with one or more aspects of the disclosure.

### DETAILED DESCRIPTION

Conventional dual flow path filter cartridges, such as those discussed above, include an integrated manifold that is attached directly to the cartridge. Coupling the manifold directly to the cartridge increases both the cost and the weight of the cartridge. To overcome these deficiencies, it is desirable to provide a separate manifold that fluidly and mechanically couples to the cartridge.

In accordance with one or more embodiments, a water filtration system is provided that includes a housing, at least one filter, and a manifold. According to certain aspects, one or more components of the water filtration system may be suitable for a retrofit application. For instance, in existing systems that include filter cartridges with an integrated manifold, i.e., the manifold is directly attached to the filter cartridge; this disclosure provides a separate manifold that may be inserted into the existing housing and is configured to fluidly couple with one or more fluid flowpaths included in the housing. One or more filter cartridges that are configured to mechanically and fluidly couple with the manifold may also be inserted into the housing. This retrofit assembly thus includes a one-time replacement manifold that may be used over and over again, and replaceable filter cartridges that are both lighter in weight and less expensive than filter cartridges that are currently available.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

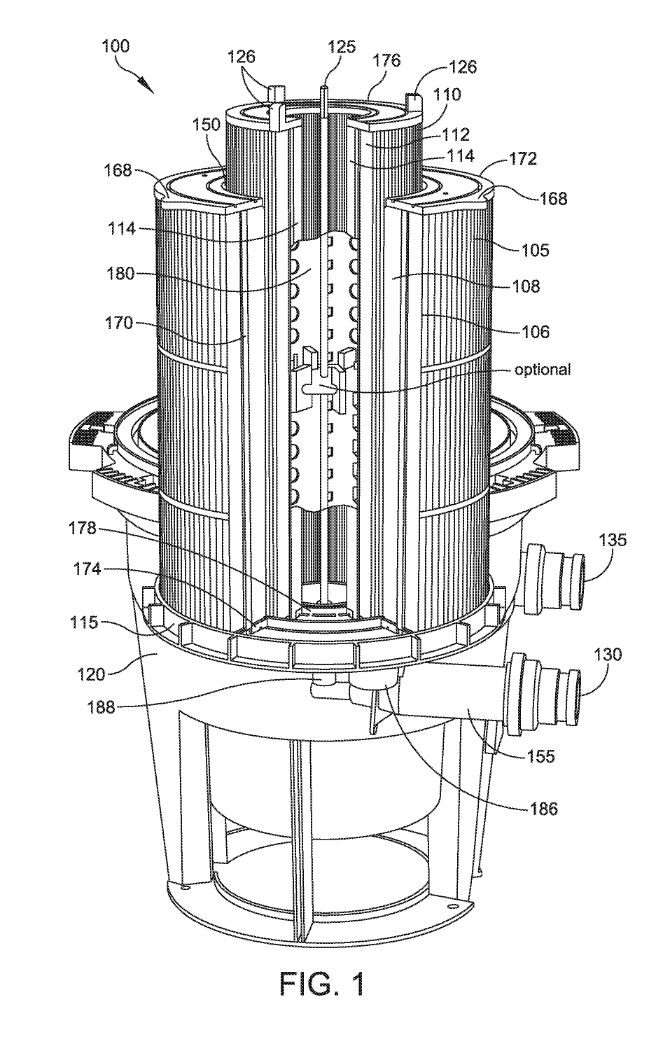

Referring to FIG. 1, a modular water filtration system, generally indicated at 100, is shown that includes a housing 120, an outer filter cartridge 105, an inner filter cartridge 110, and a manifold 115. The housing 120 may also include an inlet port 135 that is in fluid communication with unfiltered or otherwise untreated water coming from a source, such as a swimming pool or other recreational water device, such as a hot tub or whirlpool, and an outlet port 130 that is in fluid communication with filtered or otherwise treated water exiting the system 100. The outer filter cartridge 105 includes pleated filter material in the form of outer pleats 106 and inner pleats 108 that extend between an upper end cap 172 and a lower end cap 174. The outer pleats 106 are spaced apart from the inner pleats 108 by an inner support structure 170. In accordance with some embodiments, an example of an inner support structure 170 is shown in FIG. 23. According to various embodiments, the inner support structure of each of the filter cartridges functions to provide support to the cartridge during filtration processes and for removing the cartridge from the housing. For example, the inner support structure, as shown in FIG. 23, may be constructed from a polymer-based “skeleton” that includes a series of horizontal and vertical elements 171 spaced at regular intervals that function to provide structural support for the pleated filter element. In some embodiments, the top and bottom of this skeleton infrastructure are encapsulated or otherwise integrated into the upper end cap 172 and the lower end cap 174. According to another embodiment, the inner support structure may take the form of a cylindrical pipe, such as a PVC pipe, that has multiple holes punched out throughout the pipe.

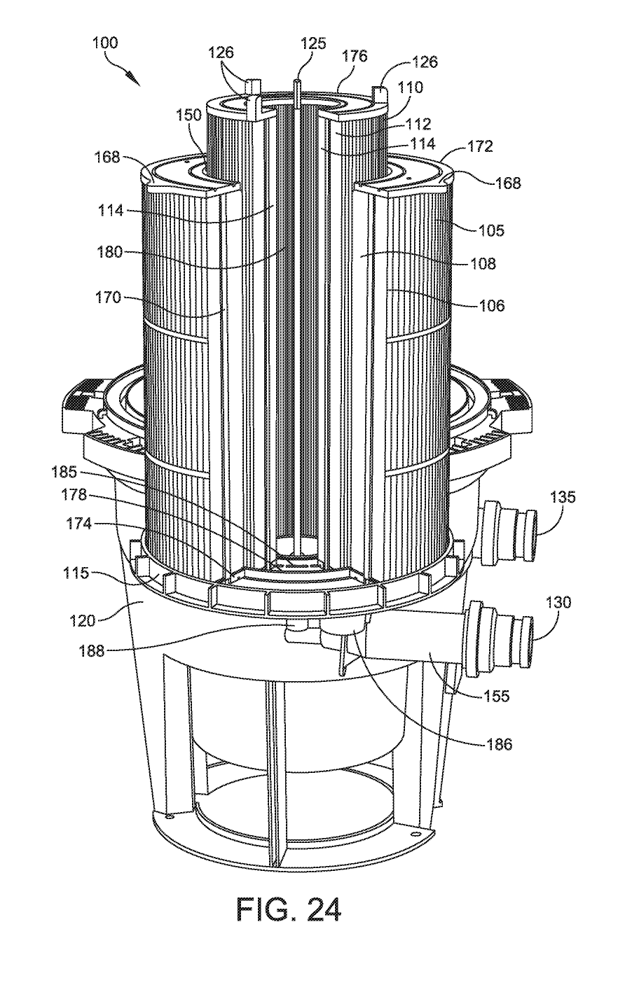

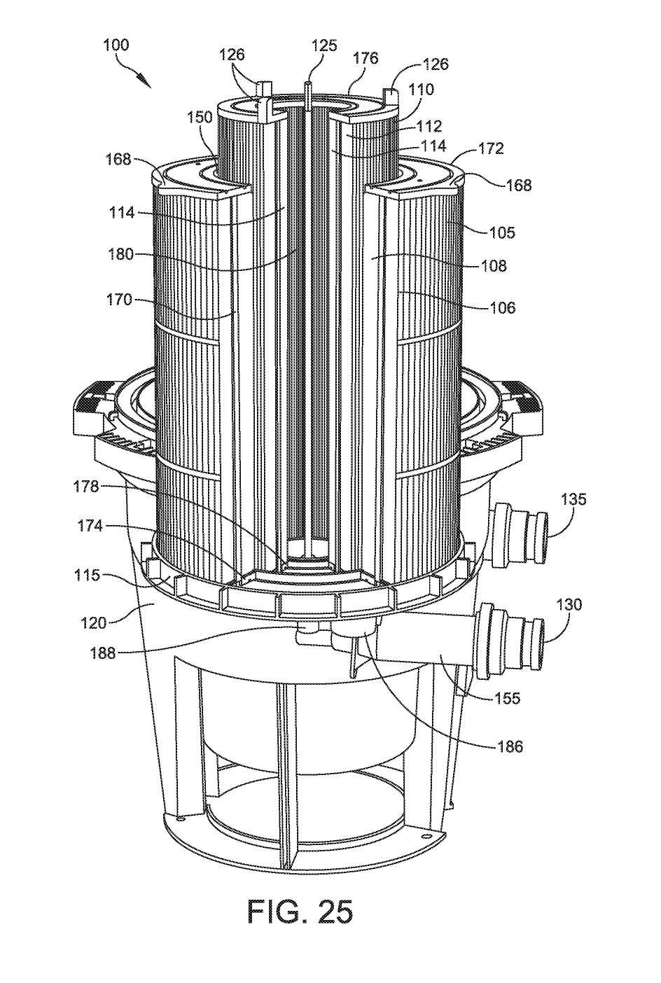

According to some embodiments, the inner filter cartridge 110 also includes outer pleats 112 and inner pleats 114 that are separated by an inner support structure, as well as an upper end cap 176 and a lower end cap 178. The upper end cap 172 of the outer filter cartridge 105 may include one or more extended portions 168 that extend laterally outward from the upper end cap 172 and function to center and anchor the outer filter cartridge 105 within the housing 120. In certain instances, the extended portions 168 may also function as lifting handles that may be used for lifting or lowering the outer filter cartridge within the housing 120. The inner filter cartridge 110 is nested within the outer filter cartridge 105 and is separated from the outer filter cartridge 105 by an annular passage 150. According to at least one embodiment, the annular passage 150 functions to allow water to enter the inner filter section of the outer filter cartridge 105, as well as the outer filter section of the inner filter cartridge 110. The upper end cap 176 of the inner filter cartridge 110 may include one or more tabs 126 that extend vertically upward from the upper end cap 176 and function to center and anchor the inner filter cartridge 110 within the housing 120. In some instances, the tabbed portions 168 may also function as lifting handles that may be used for lifting or lowering the inner filter cartridge from the housing 120. The manifold 115 is disposed within the housing 120 and includes an inner discharge port 188 and an outer discharge port 186 that are in fluid communication with filtered water that has passed through the filter cartridges 105 and 110 and the outlet port 130 via an outlet fitting 155. The water filtration system 100 also includes at least one air vent tube 125 that may be used to vent the system 100. According to various embodiments, two filter cartridges are used. As will be appreciated, more than two filter cartridges may also be used in the modular water filtration system. Using multiple filter cartridges has a number of advantages, including increased water flow through the entire apparatus, decreased pressure drop (since the filters don't become fouled as quickly), and increased life of the filters between cleanings. The structure surrounding the air vent tube 125 within the annular center region 180 (labeled as “optional”) is an optional support structure, and in instances where the inner filter cartridge 110 includes an inner filter element, this structure may be absent. FIGS. 24 and 25 are two other examples of modular water filtration systems 100 where the annular center region 180 does not include the optional support structure. The inner filter cartridge 110 shown in FIGS. 24 and 25 includes both outer pleats 112 and inner pleats 114, although in some embodiments, the inner pleats 114 may be omitted from the inner filter cartridge 110. FIG. 25 also features an alternative configuration for seating the inner filter cartridge 110 onto the manifold 115.

Although the examples shown herein include filter cartridges that feature pleated filter elements, other types of filter element structures are also within the scope of this disclosure. For example, the filtering element may comprise filtration media, such as sand, diatomaceous earth, charcoal or carbon, including activated carbon, silica, zeolite, clay, or other finely graded materials, or any other functional form of filtration.

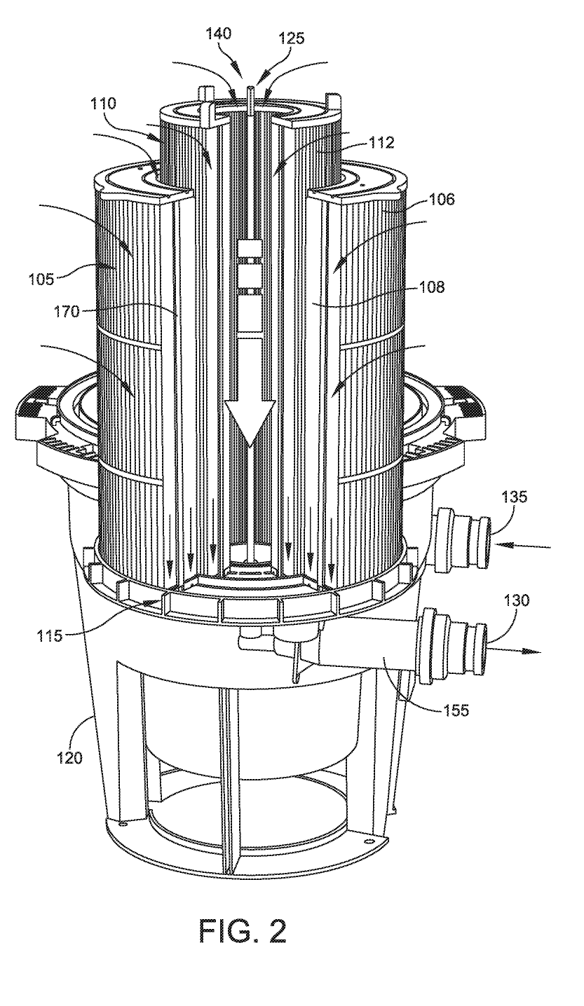

With reference to FIG. 2, during operation, contaminated fluid is first introduced into the housing 120 through inlet port 135 and enters a diffuser (not shown) that functions to diffuse the stream of contaminated fluid entering the housing 120 so that it does not directly enter into the pleats of the outer filter cartridge 105. The system is pressurized so that the contaminated fluid enters through the outer pleats 106 of the outer filter cartridge 105 as shown by the arrows, and then flows down through the annular passage 150 (see FIG. 1 for reference to annular passage), where it then enters the inner pleats 108 of the outer filter cartridge 105 and the outer pleats 112 of the inner cartridge 110. In the region above the upper end cap of the outer filter cartridge 105 the contaminated fluid enters the outer pleats of the inner filter cartridge 110 and down through the central inlet 140 into the inner pleats 114 of the inner cartridge 110.

Filtered water that has passed through the pleated elements of each of the inner and outer filter cartridges flows downward into respective inner and outer conduits 142 and 144 (not shown in FIG. 2), and inner and outer discharge ports 188 and 186 (also not shown in FIG. 2) as discussed in further detail below, of the manifold 115, where the filtered water then exits the housing 120 through the outlet port 130 via an outlet fitting 155 that is mechanically attached to the manifold 115. The filtered water may then be returned to the pool.

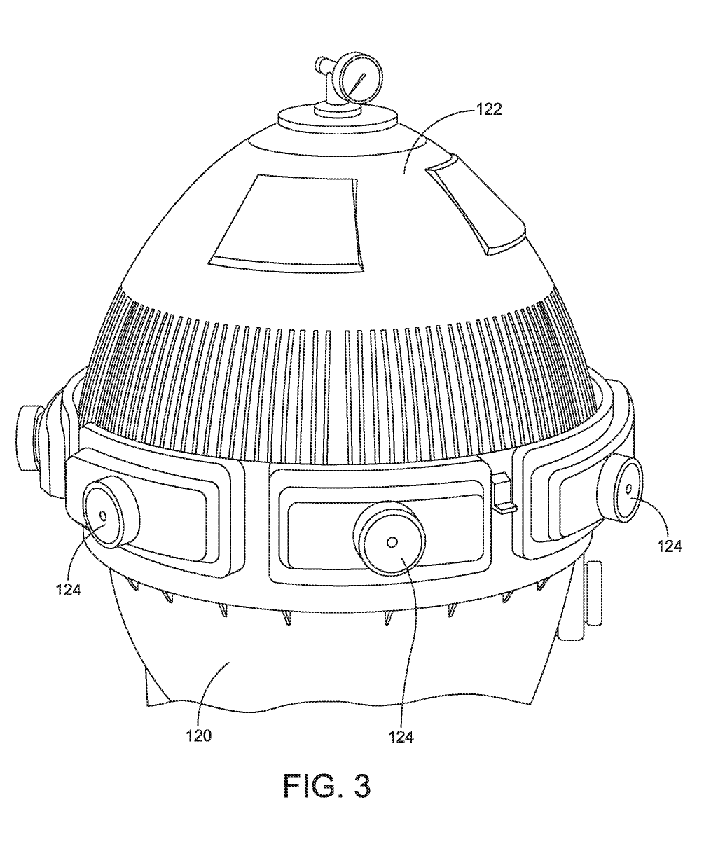

A perspective view of the exterior portion of a housing 120 that functions to confine and encapsulate the elements of the water filtration system 100 is shown in FIG. 3. The housing 120 includes a removable upper cap portion 122 that attaches to the lower portion of the housing using one or more attachment mechanisms 124 disposed around the circumference of the removable cap portion 122. Thus, the housing 120 of FIGS. 1, 2, 24, and 25 has had the upper cap portion 122 removed to show the inner contents of the water filtration system 100. According to various aspects, the housing 120 may be “quasi-spherical” in shape, meaning that the housing 120 has a circular cross-section in a first plane and a somewhat egg-shaped or elliptical cross-section in another plane normal to the first plane.

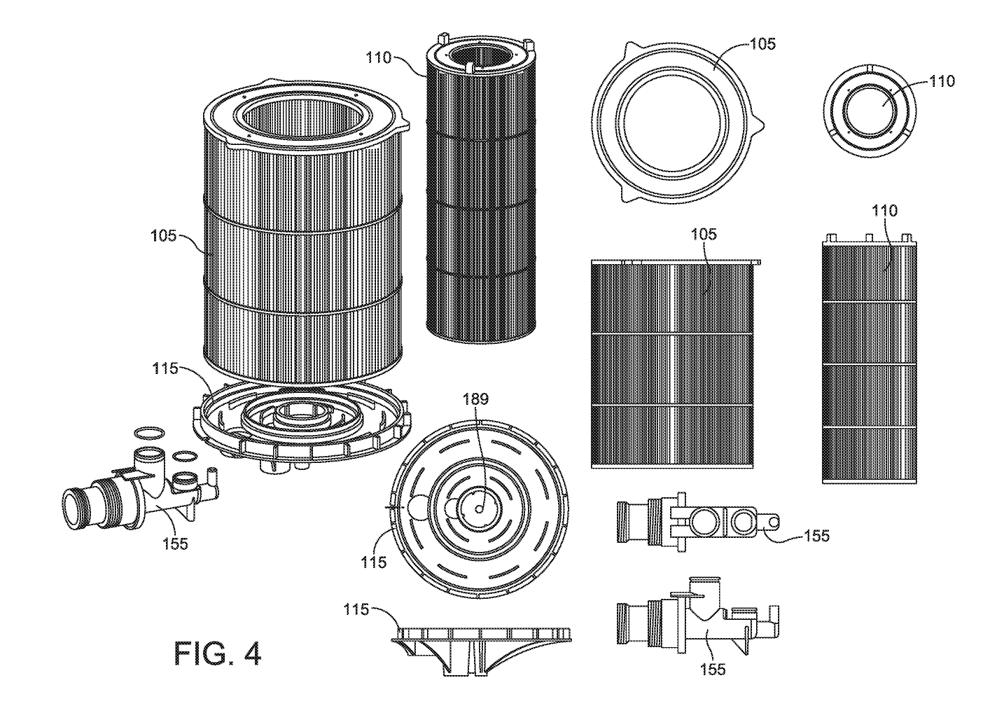

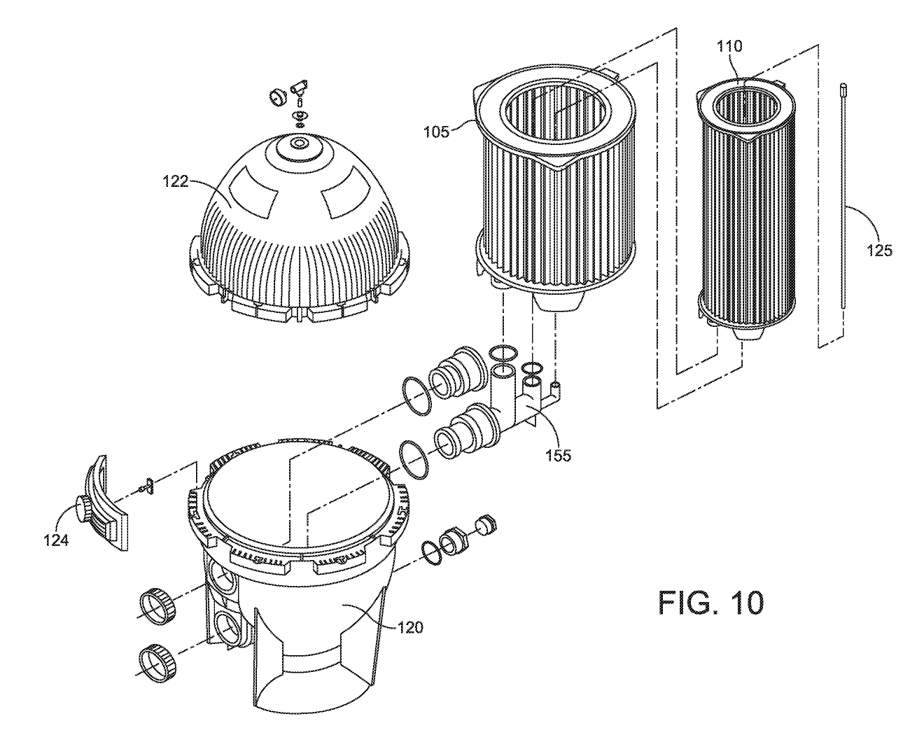

Referring to FIGS. 4 and 10, multiple views of different components of the water filtration system are shown, including the outer filter cartridge 105, the inner filter cartridge 110, the manifold 115, and the outlet fitting 155, each of which is discussed further below. For example, an exploded view of the housing 120 is shown in FIG. 10, which shows the removable cap portion 122 of the housing and the attachment mechanism 124, as discussed above in reference to FIG. 2. Notably, the filter cartridges shown in FIG. 10 are of the type that include an integrated manifold attached to the bottom of the cartridge, and are thus not of the type described herein with reference to filter cartridges 105 and 110.

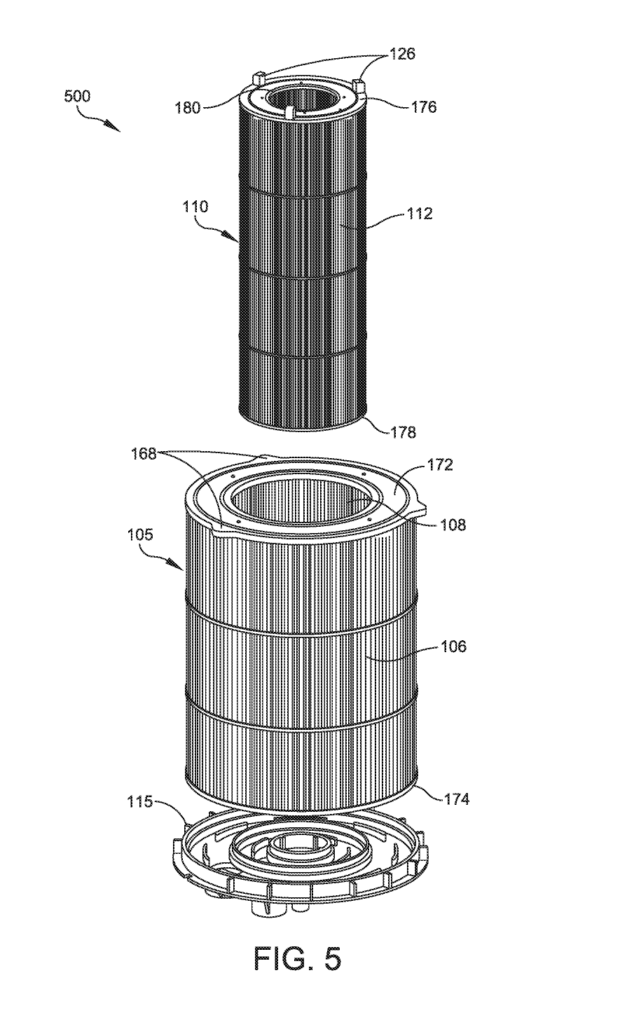

Referring next to FIG. 5, the inner filter cartridge 110 and the outer filter cartridge 105 are each generally cylindrical in shape and each include annular center regions. The outer filter cartridge 105 includes a central annular region sized to accommodate the inner filter cartridge 110, outer and inner filter element s 106 and 108, respectively, that perform the filtering function, an upper end cap 172, and a lower end cap 174. The inner filter cartridge 110 includes an annular center region 180, and also includes an outer filter element 112 and an inner filter element (not clearly shown in FIG. 5), an upper end cap 176, and a lower end cap 178. The inner filter cartridge 110 is sized to “nest” or otherwise fit concentrically within the annular center region of the outer filter cartridge 105. Therefore, the inner filter cartridge 110 has a smaller diameter than the outer filter cartridge 105. In addition, according to some embodiments, the inner filter cartridge 110 may have a longer length than the outer filter cartridge 105. When fitted into position, the inner filter cartridge 110 is spaced from the outer filter cartridge 105, and both filter cartridges are configured to mechanically and fluidly couple to the manifold 115, as discussed further below. For example, the manifold 115 may include one or more guide structures that function to guide the filter cartridges to be seated and centered properly within the system. Although two filter cartridges are shown, as discussed above it is to be understood that the system may include more than two filter cartridges, i.e., three or more cartridges.

In accordance with one or more aspects, one or more of the inner filter cartridge 110, the outer filter cartridge 105, and the manifold 115 shown in FIG. 5 may form one or more components of a replacement kit, generally indicated at 500 in FIG. 5. For instance, as mentioned above, a pre-existing water filtration system may include filter cartridges that have an integrated manifold that is mechanically attached to a lower portion of the cartridge. Once the filter(s) are removed from the housing of the system, one or more components of the replacement kit 500 may be used in place of the removed filters. For instance, the manifold 115 may first be aligned and positioned within the housing 120, as illustrated in FIG. 9, and then the outer filter cartridge 105 may be aligned (as discussed further below) and positioned within the housing 120 so as to be fitted to the manifold 115. The inner filter cartridge 110 may then be aligned (as discussed further below) and positioned within the housing 120 so as to be within the annular region of the outer filter cartridge 105 and so as to be fitted to the manifold 115. Once the filter cartridges 105 and 110 have reached the end of their useful life, they may be replaced by new filter cartridges, while still using the same replacement manifold 115. Thus, once the manifold 115 is installed, it may be used over and over again without having to remove it from the housing 120. Without the attached manifold, the filter cartridges are both lighter in weight and cheaper to manufacture. The filter cartridges 105 and/or 110 may be replaced as part of a regular maintenance regime, and/or as they become fouled, while the manifold 115 remains in place within the system.

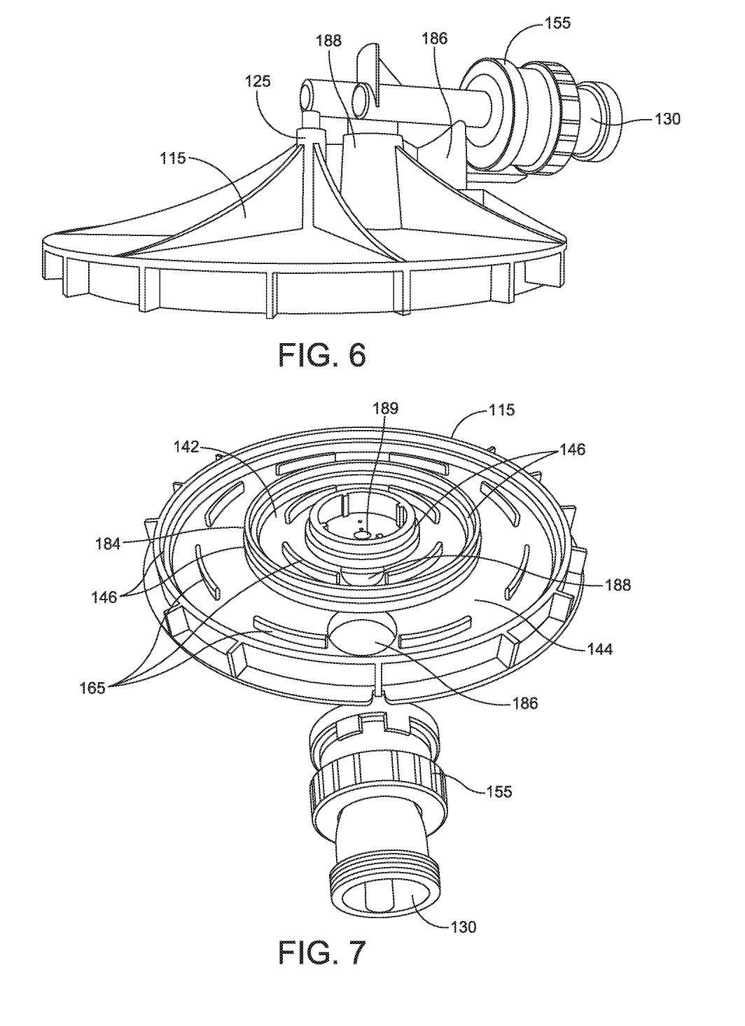

Other views of the manifold 115 and outlet fitting 155 are shown in FIGS. 6 and 7. For example, FIG. 6 illustrates how the bottom of the manifold 115 attaches to the outlet fitting 155 and FIG. 7 shows a top view of the manifold 115 attached to the outlet fitting 155. FIG. 7 illustrates several fluid and mechanical structures included in the manifold 115. For example, the manifold 115 may include an outer conduit 144 that is in fluid communication with fluid that passes through the outer filter cartridge 105 and an inner conduit 142 that is in fluid communication with fluid that passes through the inner filter cartridge 110. The outer conduit 144 and the inner conduit 142 are fluidly separated by a divider 184. Filtered fluid then exits the manifold through either an outer discharge port 186 disposed in the outer conduit 144 or an inner discharge port 188 that is disposed in the inner conduit 142. Although not clearly shown in FIG. 6, each of the outer conduit 144 and the inner conduit 142 may be sloped to tilt slightly downward toward the respective discharge ports 188 and 186 so as to facilitate fluid flow out of the manifold 115. According to other embodiments, the outer conduit 144 and the inner conduit 142 are not sloped, i.e., they are flat. In certain instances this configuration allows for the filter cartridges to be seated in a level position within the housing. Both the outer discharge port 186 and the inner discharge port 188 are in fluid communication with the outlet fitting 155, which includes the outlet port 130. According to various aspects, the outlet fitting 155 is integrated or otherwise a part of a pre-existing housing 120 and thus the manifold 115 is configured to fluidly couple to the outlet fitting 155, as shown in FIG. 6, where the outlet fitting 155 has been removed from the housing 120 for purposes of illustration. For instance, each of the outer discharge port 186 and inner discharge port 188 are configured to couple to respective openings on the outlet fitting 155. Also included in the manifold 115 is a center port 189 that is configured to accommodate or otherwise position the air vent tube 125, which functions to vent air from the system. The center port 189 of the manifold 115 is also in fluid communication and couples to a respective opening or port in the outlet fitting 155, as shown in FIGS. 6 and 7.

Also shown in FIG. 7 are several support structures 146, and alignment features 165, which function to position and seat the inner and outer filter cartridges 110 and 105. For example, the outer conduit 144 includes two support structures 146, which in this instance are two “shoulders” or rims that are positioned on the inner and outer circumference that form the perimeters of the outer conduit 144. Several alignment features 165, which in this instance are raised “ridge” features, are also positioned at regular intervals in an annular arrangement at or near the center of the outer conduit 144. The alignment features 165 have a slightly greater vertical height than the support structures 146. After the manifold 115 has been positioned within the housing 120, the outer filter cartridge 105 is then lowered down onto the alignment features 165, which are spaced and sized to “mate” with openings 182 positioned on the lower end cap 174 of the outer filter cartridge 105, as shown and discussed further below in reference to FIG. 12. When initially lowered into position, the lower end cap 174 rests on top of the alignment features 165, but can then be rotated so that the openings 182 of the lower end cap align with the ridges forming the alignment features 165. Once the openings 182 and alignment features 165 are aligned and mated together, the outer filter cartridge drops slightly, allowing the lower end cap 174 to rest and be seated onto the shoulders forming the support structures 146.

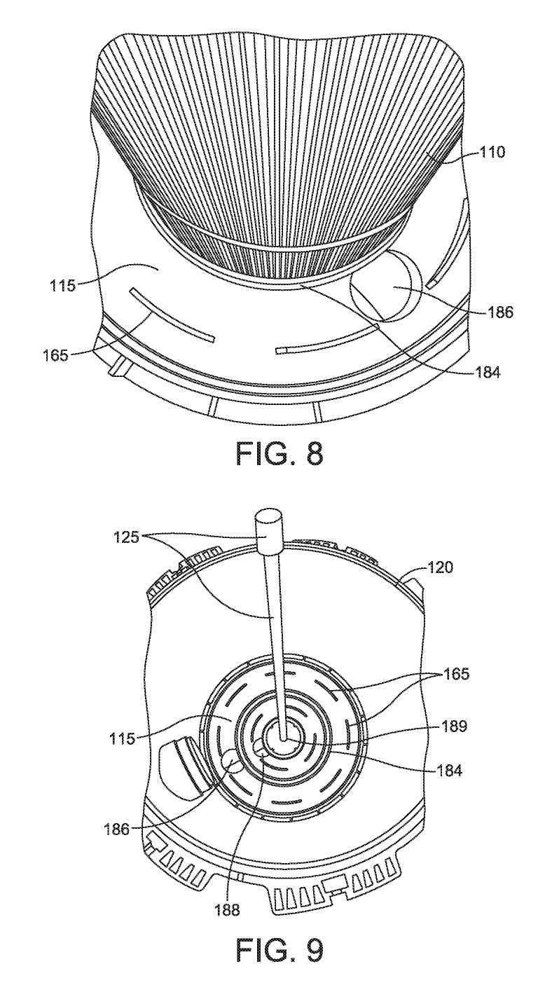

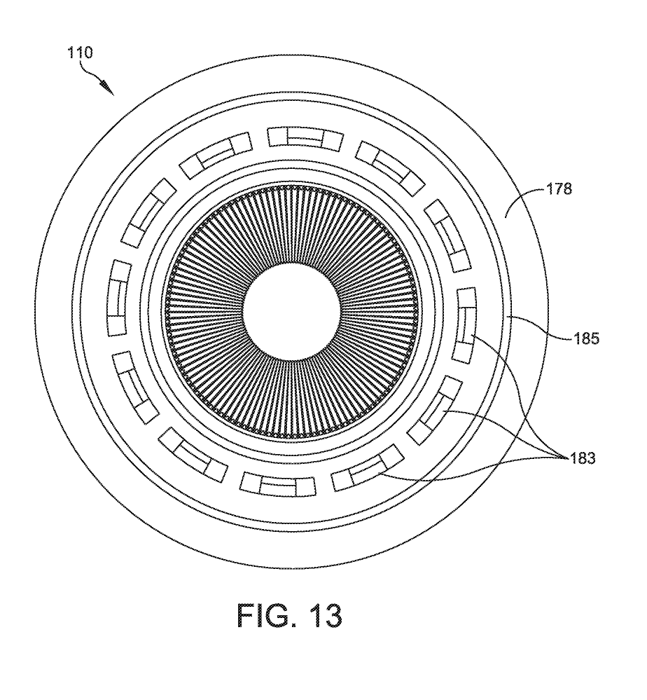

The alignment and positioning process described above with respect to the outer filter cartridge 105 is also applied to the inner filter cartridge 110, but may include slightly different features. The inner filter cartridge 110 is lowered into position so that the ridges forming the alignment feature 165 mate with a recess 185 formed in the lower end cap 178, as shown in FIG. 13. The recess 185 is of a depth and is positioned to accommodate the ridges of the alignment feature 165 formed in the inner conduit 142. In addition, the inner and outer edges of the lower end cap 178 rest on the support structures 146 formed on the inner and outer perimeters of the inner conduit 142, so that the inner filter cartridge 110 is seated within the manifold 115. An example of an inner filter cartridge 110 seated within the manifold 115 is shown in FIG. 8. As shown in FIG. 8, the inner filter cartridge 110 is sized to fit within the divider 184 forming the separation between the inner and outer conduits 142 and 144. The lower end cap 178 for the inner filter cartridge 110 also includes several openings, but in this particular instance, these openings function as outlet ports 183, as shown in FIG. 13, for fluid passing through the filter element to drain down and out into the inner conduit 142.

An example of an installed manifold 115 within the housing 120 is shown in FIG. 9. The manifold 115 may be lowered into the housing 120 and although not shown, the inner and outer discharge ports 188 and 186 are also aligned with openings in the outlet fitting 155. In addition, the hole forming the center port 189 for the air vent tube 125 is also aligned with an opening in the outlet fitting 155. Once each of these features is aligned, then the manifold 115 can be pushed down firmly into a final installed position. The configuration shown in FIG. 9 also includes an example of an air vent tube 125. In certain instances, this tube may be positioned and installed after the manifold 115 and before or after the air filter cartridges 105 and 110.

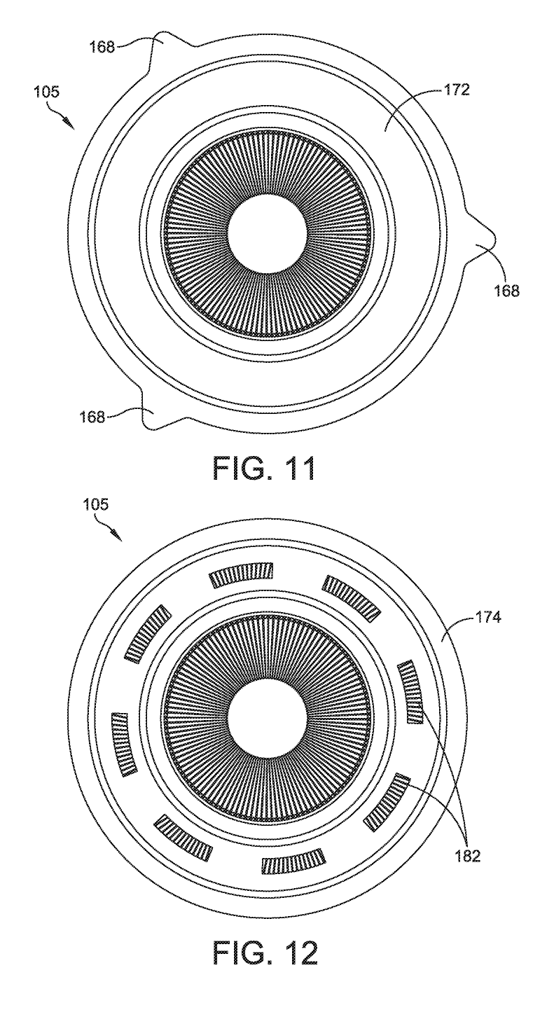

Referring to FIGS. 11 and 12, the upper end cap 172 and lower end cap 174 of the outer filter cartridge 105 are shown, respectively. The upper end cap 172 includes several extended portions 168 that may function to center and anchor the outer filter cartridge 105 within the housing, and may also be used for lifting and lowering the outer filter cartridge 105 from the housing 120. For example, the extended portions 168 may rest against the inner wall of the housing 120 and thus ensure that the filter cartridge is centered within the housing 120. The lower end cap 174 includes several openings 182 that are spaced at regular intervals around a circumference of the lower end cap 174. As discussed above, these openings 182 are sized and shaped to mate with the raised ridges forming the alignment features 165 included within the outer conduit 144 of the manifold 115. The inner and outer edges of the lower end cap 174 are also constructed from solid material and have a smooth surface so that they can be seated onto the support structures 146 of the outer conduit 144.

Referring to FIG. 13, the lower end cap 178 of the inner filter cartridge 110 is shown. As discussed above, the lower end cap 178 includes openings that function as outlet ports 183 for filtered water to exit and drain into the inner conduit 142 of the manifold 115, as discussed above. Also included in the lower end cap 178 is a groove or recess 185 that is sized and shaped to mate with the raised ridges forming the alignment features 165 included within the inner conduit 142. The lower end cap 178 also includes inner and outer edges that are constructed so that they can be seated onto the inner and outer rims that form the support structures 146 of the inner conduit 142.

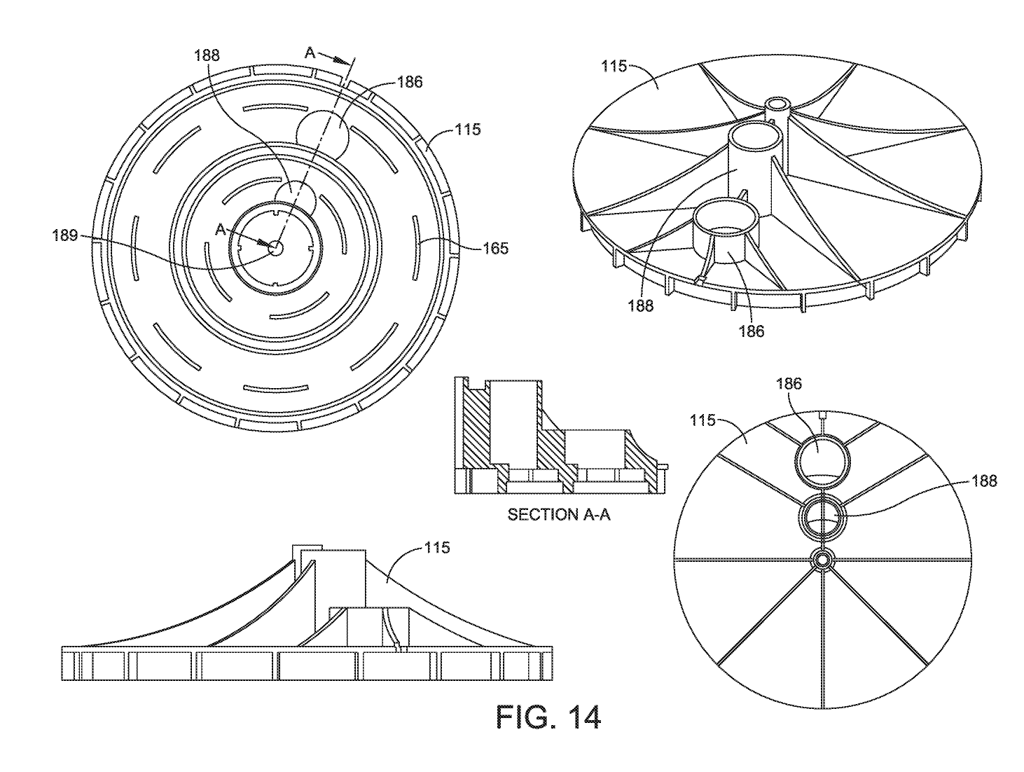

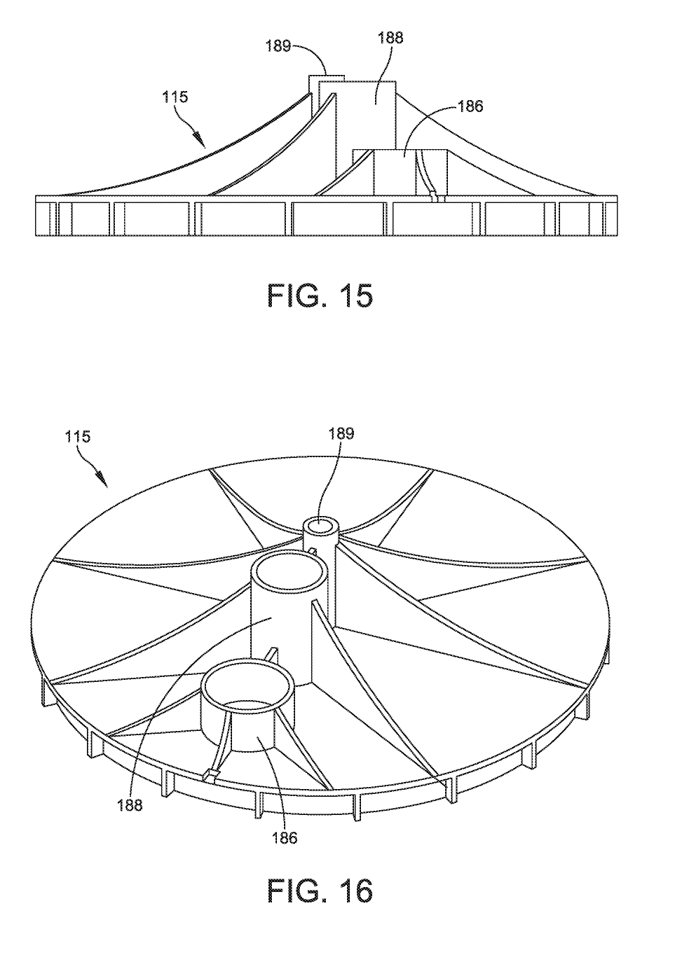

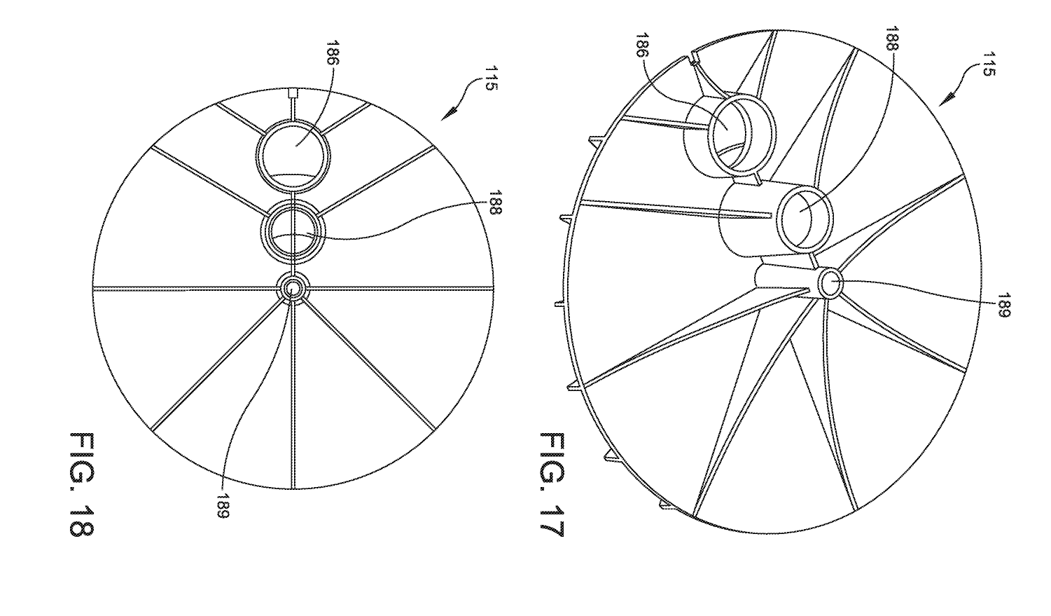

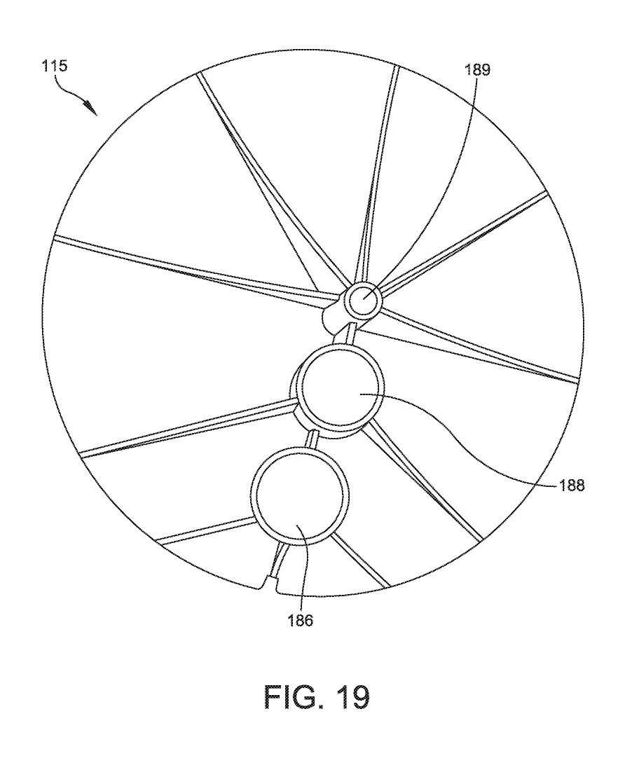

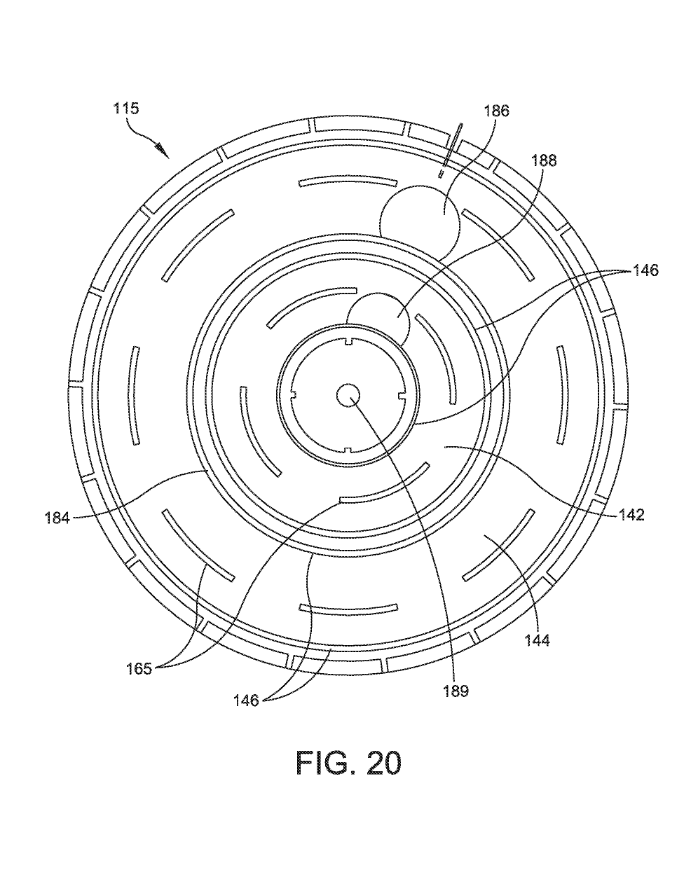

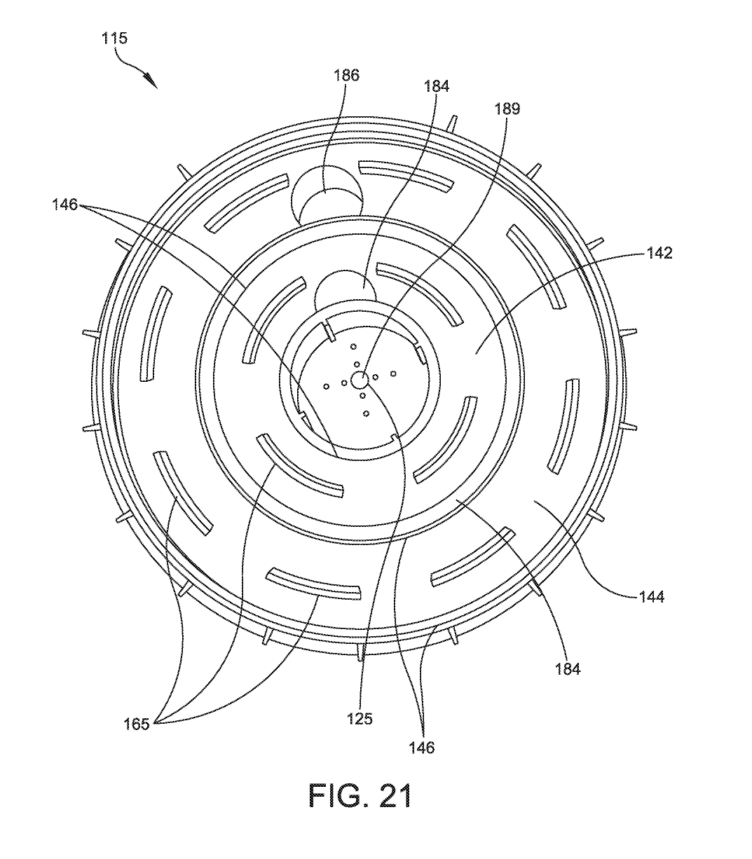

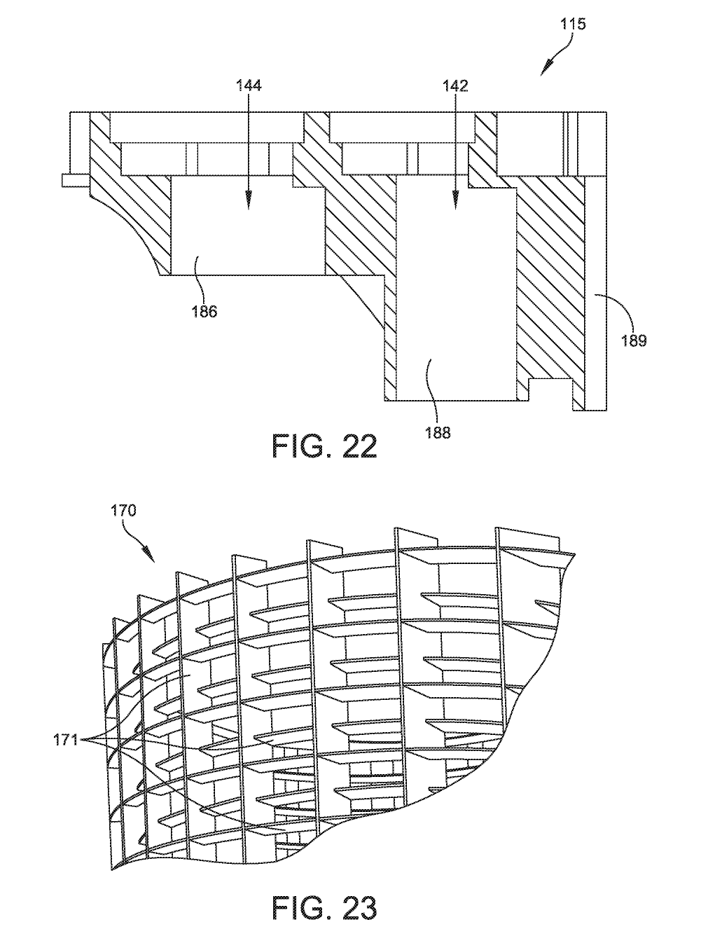

Referring to FIGS. 14-22, various views are shown of the manifold 115 that may be used within the housing 120 of the water filtration system 100. For instance, FIG. 15 includes a side elevation view of the manifold 115 that has an outer perimeter sized and shaped to fit within the inner contours of the housing 120 and includes the outer discharge port 186 that is in fluid communication with the outer conduit 144 (e.g., see FIG. 20), the inner discharge port 188 that is in fluid communication with the inner conduit 142 (e.g., see FIG. 20), and the center port 189 that may hold an air vent tube 125 that extends from and through the manifold 115 up to the top of the inner filter cartridge 110. For example, the air vent tube 125 may pass through the center port 189 and extend into a port or other opening of the outlet fitting 155. FIGS. 16-19 show various bottom views of the same manifold 115 shown in FIG. 15. FIGS. 20 and 21 are top views of the manifold 115 shown in FIGS. 14-19. As discussed above, the manifold 115 includes an outer conduit 144 and an inner conduit 142 that each include alignment features 165 and support structures 146 that are configured to align and install the respective outer and inner filter cartridges 105 and 110. The outer discharge port 186 and the inner discharge port 188 of the outer and inner conduits 144 and 142, respectively, are also in fluid communication with the outlet fitting 155, as is the center port 189 positioned in the center of the manifold 115. An annular divider 184 is also included in the manifold 115 that functions to separate the inner and outer conduits 142 and 144. FIG. 22 is a partial cross-sectional view of the manifold 115 and shows with arrows how fluid may exit the outer conduit 144 and the inner conduit 142 and enter the outer discharge port 186 and inner discharge port 188, respectively.

The manifold 115 may be constructed using an injection molding process, as understood by one of skill in the art, and may be made from any one or more of a number of different materials, including nylon or other polymer materials. The manifold 115 may be constructed from any sturdy, lightweight, and rigid polymer material such that it is capable of withstanding pressures associated with the filtration process. For example, the manifold may be constructed from material capable of withstanding process pressures that reach 80 psi. According to various aspects, the manifold 115 may be removed from the housing 120 and cleaned as needed.

Although not shown in the accompanying figures, the filtration system discussed above may also include one or more other components that facilitate the processes disclosed herein. For example, the filtration system may also include at least one pump, conduits, such as tubing or pumping, valves, pressure gauges, and the like.

### Example

The system described herein will be further illustrated through the following example, which is illustrative in nature and is not intended to limit the scope of the disclosure.

### Example Retrofit Water Filtration Assembly

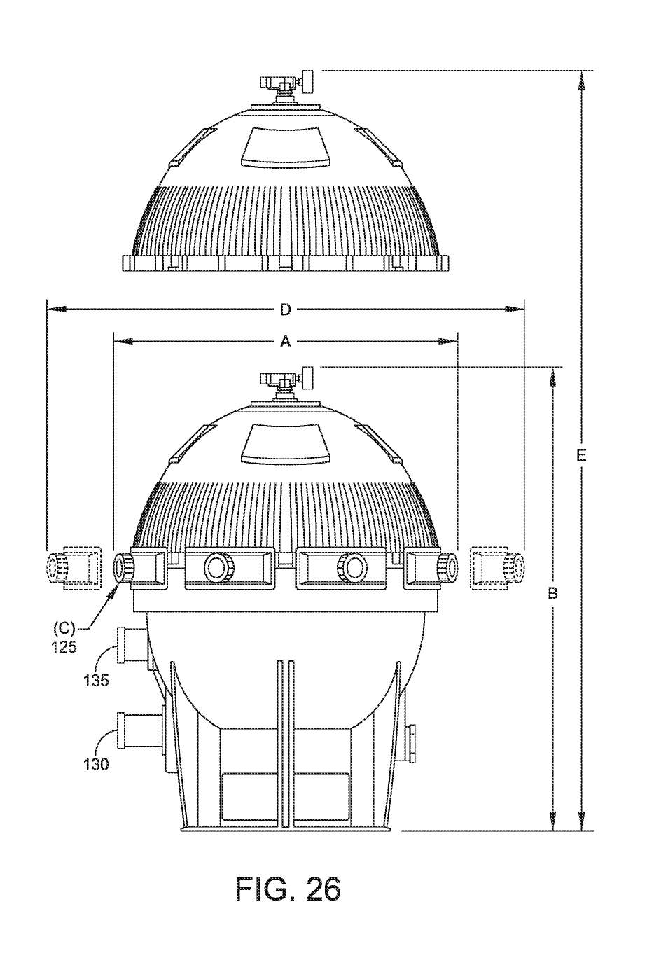

An embodiment of one example in accordance with at least one aspect of this diclosure was assembled as shown in FIGS. 1-3 and 24, and includes the components as shown in FIGS. 4 and 14, with the exception of the outlet fitting, which was already included in an existing filtration assembly. An existing Pentair STA-RITE® System: 3® Mod Media™ filtration system (see FIG. 10) was retrofitted with a manifold, an inner filter cartridge, and an outer filter cartridge as shown in FIGS. 4 and 14 (currently marketed as the ECO3 retrofit system available from FILBUR Manufacturing (Buena Park, Calif.)). FIG. 26 illustrates an example of the housing associated with these systems. These housings have the structure and dimensions as listed below in Table 1:

TABLE 1
Housing Characteristics (FIG. 23)

| | | | | Dimension D | Dimension E |
|---|---|---|---|---|---|
| | | | | Area (width) | Area (height) |
| | | | | needed to | need to remove |
| | Dimension A | Dimension B | Dimension C | take off | top half |
| | Width | Height | Number | clamps | of tank |
| Catalog # | (inches) | (inches) | of Clamps | (inches) | (inches) |
| S7M120/S7M400 | 28.5 | 42 | 7 | 36 | 50 |
| S8M150/S8M500 | 32.5 | 42.25 | 8 | 40 | 50 |

The inner and outer filter cartridges used in this example correspond to FILBUR model numbers ECO3-301 and ECO3-302, respectively. Each of these filters includes pleated filter elements and is sized and shaped to fit within the aforementioned System: 3® system and are illustrated in FIGS. 4, 5, 11, and 12 and each include a support structure similar to the one shown in FIG. 23. The outer filter cartridge of the subject disclosure may be sized and used to replace the large cartridge corresponding to existing System: 3® part numbers 25022-0201S, 25022-224S, 25022-0203S, or 25022-0225S, and the inner filter cartridge of the subject disclosure may be sized and used to replace the small cartridge corresponding to existing System: 3® part numbers 25021-0200S, 25021-0223S, 25021-0202S, or 25021-0224S.

The manifold of the subject disclosure is sized and shaped to accommodate any of the inner and outer cartridges of the subject disclosure that are in turn designed to replace the aforementioned existing System: 3® filtration cartridges. FIG. 14 is an example of a manifold that is dimensioned to mechanically couple with an existing housing such as one of those shown in FIG. 26. According to this example, the distance between the center of the center port of the manifold and the center of the inner discharge port of the manifold is 2.352 inches, the distance between the center of the center port of the manifold and the center of the outer discharge port of the manifold is 5.612 inches, and the distance from the center of the center port of the manifold to the outer edge of the manifold is 8.5 inches. In addition, the center of FIG. 14 shows the cross-section A-A of the manifold taken along section A-A from the top view of the manifold 115 shown in the upper left corner of FIG. 14. The cross-section A-A has the following dimensions: the height of the center port is 4.663 inches, the height of the inner discharge port is 4.524 inches, and the height of the outer discharge port is 2.548 inches. The example of the manifold illustrated in FIG. 14 also shows that each of the ports of the manifold is formed from a solid material that is roughly in the shape of a cylindrical tube. The length of the inner radius of the outer discharge port is 2.420 inches, and the outer radius is 2.795 inches, thus the thickness of the “lip” forming the outer discharge port is 0.375 inches. Likewise, the outer and inner radii of the inner discharge port are 2.275 and 1.900 respectively, and the outer and inner radii of the center port are 1.045 and 0.670 respectively. Thus, the thickness of the “lips” for all three ports is 0.375 inches. Further, each of the center points of the center port, inner discharge port, and outer discharge port of the manifold are all distributed along the same radial axis, as shown in FIG. 14.

The retrofit process included disassembling the existing filter system according to the owner's instruction manual, e.g., removing the cap from the housing and any existing filters from the housing. Then, the FILBUR ECO3 manifold, i.e., a manifold in accordance with this disclosure, was lowered into the housing of the existing system so that it rested on a filter elbow and the outlet fitting. The manifold was also aligned with the outlet fitting so that the center port and inner and outer discharge ports of the manifold aligned with the corresponding ports of the outlet fitting. The manifold was then pushed down into the housing for a distance of about one-quarter of an inch. Once the other ports of the system were confirmed to be aligned correctly, the manifold was pushed further down until it was firmly in place such that it sat flat within the housing.

Next, the outer filter cartridge (corresponding to model number ECO3-302) was lowered into the housing so that the lower end cap rested on the raised ridges formed within and around the outer conduit of the manifold. The outer filter cartridge was then rotated until the openings of the lower end cap mated with the raised ridges and the outer filter cartridge lowered into a final position such that it was seated against the support structure formed within the outer perimeter of the outer conduit. A similar process was then performed for the inner filter cartridge (corresponding to model number ECO3-301) such that the inner filter cartridge was lowered into the housing and aligned with the raised ridges formed within the inner conduit and then dropped into place such that the inner fluid cartridge was seated against the support structure formed within the outer perimeter of the inner conduit. The air vent tube was then lowered down through the open central annular region of the inner filter cartridge and pushed into place within the center port of the manifold. The cap was then placed back onto the housing.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A water filtration system comprising:
a housing having an inlet port and an outlet port;
at least one filter cartridge disposed within the housing and in fluid communication with unfiltered water introduced through the inlet port of the housing; and
a manifold disposed within the housing and having at least one discharge port in fluid communication with the outlet port and at least one conduit in fluid communication with filtered water that has passed through the at least one filter cartridge, the manifold configured to mechanically couple to the at least one filter cartridge and the housing.

2. The water filtration system of claim 1, wherein the manifold includes at least one alignment feature configured to mate with a recess disposed on a lower end cap of the at least one filter cartridge.

3. The water filtration system of claim 2, wherein the recess is a continuous groove.

4. The water filtration system of claim 2, wherein the recess is a series of openings.

5. The water filtration system of claim 1, wherein the at least one filter cartridge includes at least one outlet port configured to be in fluid communication with the at least one conduit of the manifold.

6. The water filtration system of claim 1, wherein the at least one filter cartridge includes an outer filter cartridge having a central annular region and an inner filter cartridge disposed within the central annular region of the outer filter cartridge, each of the outer filter cartridge and the inner filter cartridge in fluid communication with the manifold.

7. The water filtration system of claim 6, wherein the at least one conduit of the manifold includes an outer conduit and an inner conduit, and the outer filter cartridge is in fluid communication with an outer conduit and the inner filter cartridge is in fluid communication with the inner conduit.

8. A kit for retrofitting an existing water filtration system, comprising:
at least one filter cartridge configured to be disposed within the existing water filtration system; and
a manifold configured to be disposed within the existing water filtration system, to mechanically couple to the at least one filter cartridge, and having at least one discharge port configured to couple to an outlet of the existing water filtration system.

9. The kit of claim 8, wherein the at least one filter cartridge is configured to be in fluid communication with unfiltered water introduced through an inlet of the existing water filtration system, and the manifold further includes at least one conduit in fluid communication with filtered water that has passed through the at least one filter cartridge and in fluid communication with the at least one discharge port.

10. The kit of claim 9, wherein the at least one filter cartridge includes at least one outlet port configured to be in fluid communication with the at least one conduit of the manifold.

11. The kit of claim 9, wherein the at least one filter cartridge includes an outer filter cartridge and an inner filter cartridge.

12. The kit of claim 11, wherein the at least one conduit includes an outer conduit configured to be in fluid communication with the outer filter cartridge, and an inner conduit configured to be in fluid communication with the inner filter cartridge.

13. A manifold, comprising:
a first conduit configured to be in fluid communication with a first filter cartridge;
a second conduit configured to be in fluid communication with a second filter cartridge; and
at least one discharge port in fluid communication with the first conduit, the second conduit, and an outlet of a water filtration system.

14. The manifold of claim 13, further including at least one alignment feature configured to mate with the first and second filter cartridges.

15. The manifold of claim 14, wherein the at least one alignment feature is at least one of a continuous groove and a series of openings.

16. The manifold of claim 13, wherein the first conduit is an outer conduit and the second conduit is an inner conduit such that the inner conduit is nested within the outer conduit.

17. The manifold of claim 16, wherein the outer conduit and the inner conduit are in fluid communication with an outlet fitting coupled to the outlet of the water filtration system.

18. The manifold of claim 17, wherein the at least one discharge port includes an outer discharge port in fluid communication with the outer conduit and the outlet fitting, and an inner discharge port in fluid communication with the inner conduit and the outlet fitting.

19. The manifold of claim 17, further comprising a center port configured to couple to the outlet fitting.

20. The manifold of claim 13, wherein the first conduit is in fluid communication with filtered water that has passed through the first filter cartridge and the second conduit is in fluid communication with filtered water that has passed through the second filter cartridge.
